(19) United States
(12) Patent Application Publication
(10) Pub. No.: US 2016/0231523 A1
(43) Pub. Date: Aug. 11, 2016

(54) HIGH TEMPERATURE FIBER OPTIC CABLE

(71) Applicant: SHELL OIL COMPANY, Houston, TX (US)

(72) Inventors: Dhruv ARORA, Houston, TX (US); Souliman MAKLAD, Houston, TX (US); Stephen Taylor THOMPSON, Houston, TX (US); Garcia Sergio VAZQUEZ, Houston, TX (US); Alexei TCHERNIAK, Houston, TX (US)

(21) Appl. No.: 15/022,839

(22) PCT Filed: Sep. 11, 2014
(86) PCT No.: PCT/US2014/055147

§ 371 Date: Mar. 17, 2016

Related U.S. Application Data
(60) Provisional application No. 61/879,754, filed on Sep. 19, 2013.

(51) Int. Cl. G02B 6/44; G02B 6/02; G02B 6/50

(52) U.S. Cl. CPC G02B 6/4436; G02B 6/4432; G02B 6/504; G02B 6/4486; G02B 6/02395

(57) ABSTRACT

A fiber optic cable includes an outer tube, a ceramic fiber sleeve within the outer tube, and an optical fiber having a metal plating within the ceramic fiber sleeve. A method of forming a fiber optic cable includes placing a metal plated optical fiber in a ceramic fiber sleeve, and placing the ceramic fiber sleeve in an outer tube.

### FIELD OF THE INVENTION

The invention relates to fiber optic cables, and more particularly, to fiber optic cables for use in high temperature or other harsh environments.

### BACKGROUND

With advancements in the area of fiber optic sensors, particularly for use in harsh environments, such as in oil and gas wells, there is an increasing need for fiber optic cables that can survive harsh environments. For example, the harsh environment encountered in subterranean fiber optic sensing applications places demanding requirements on the design of fiber optic cables for use in the subterranean environment. Such a fiber optic cable may be used to interconnect a subterranean fiber optic sensor with instrumentation located at the surface of a well bore.

Subterranean environmental conditions can include temperatures in excess of 550° C., hydrostatic pressures in excess of 10 bar, vibration, and corrosive chemistry. Subterranean applications also lead to the requirement that the fiber optic cable be produced in lengths of 1000 m and longer while surviving and functioning in the harsh environments.

For certain high temperature applications, metal plating of optical fibers has been proposed to provide protection to the optical fibers, which are placed in metal sheathing. However, upon heating, some metals have been found to adhere to the interior of metal sheathing surrounding the optical fibers, resulting in breakage or other damage to the optical fibers in tensile loading upon cooling. Additionally upon repeated physical cycling of the optical fiber in the metal sheathing, some metal plating from the optical fibers has been found to wear away on the inside of the metal sheathing surrounding the optical fibers.

### SUMMARY OF THE INVENTION

In some embodiments of the present disclosure, a fiber optic cable includes an outer tube, a ceramic fiber sleeve within the outer tube, and an optical fiber having a metal plating within the ceramic fiber sleeve.

In a method according to the present disclosure, a fiber optic cable is formed by placing a metal plated optical fiber in a ceramic fiber sleeve, and placing the ceramic fiber sleeve in an outer tube.

### BRIEF DESCRIPTION OF THE FIGURES

FIG. 1 is a side view of the fiber optic cable of the present disclosure.

FIG. 2 is a cross sectional view of the fiber optic cable of FIG. 1, taken through line A-A.

FIG. 3 is a perspective view of the fiber optic cable of FIG. 1 within a well bore.

### DETAILED DESCRIPTION

The fiber optic cables described herein may be used in harsh environments, particularly at high temperatures. Optical fibers contained in the fiber optic cables may not be exposed to significant damaging strain over a wide range of operating temperatures.

The fiber optic cables may generally include an optical fiber surrounded by a metal plating and a surrounding protective layer. The surrounding protective layer may include an outer tube received over the metal plated optical fiber, and a layer of ceramic material positioned between the outer tube and the metal plated optical fiber, the ceramic material maintaining the metal plated optical fiber generally centrally located within the outer tube and providing a mechanical link between the metal plated optical fiber and the outer tube to prevent relative movement between the fiber and the tube.

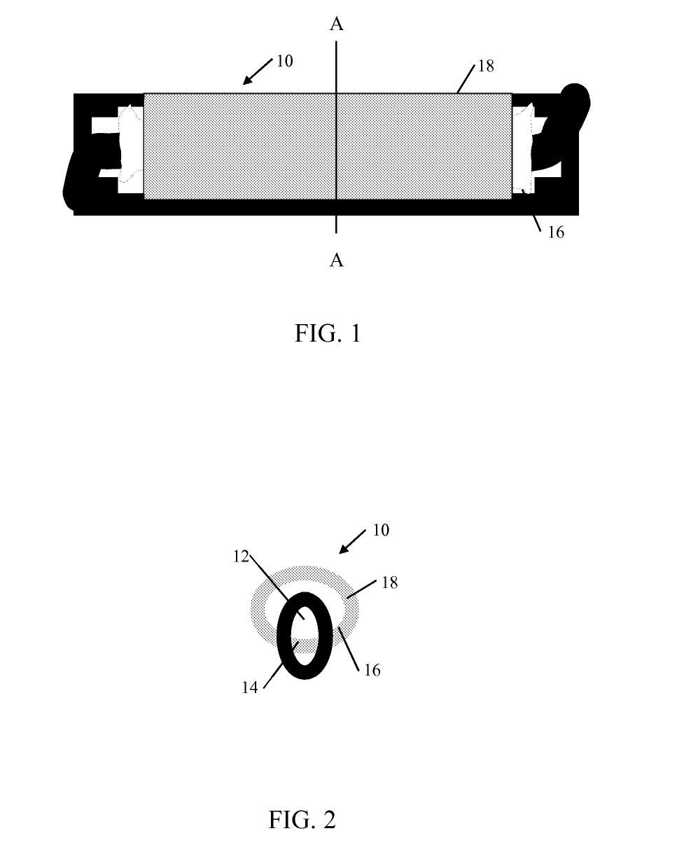

Referring now to FIGS. 1 and 2, a fiber optic cable 10 may include an outer tube 18, a ceramic fiber sleeve 16 within the outer tube 18, and an optical fiber 12. The optical fiber 12 may be a polymer fiber within the ceramic fiber sleeve 16 without plating thereon. Alternatively, the optical fiber 12 may have a metal (e.g., gold, silver, etc.) plating 14 within the ceramic fiber sleeve 16. The metal plating 14 may surround one or more optical fibers 12 in the ceramic fiber sleeve 16. The diameter of the optical fiber 12 may be in the range of 0.01 mm to 0.2 mm, and in an exemplary embodiment may be 0.1 mm. Although the optical fiber 12 is described as being 0.01 mm to 0 2 mm in diameter, the diameter of the optical fiber 12 may vary over a large range, depending upon the materials used and the number of optical fibers 12 to be placed in the fiber optic cable 10. Similarly, the outer diameter of the metal plating 14 of the optical fiber 12 may be in the range of 0.05 mm to 0.5 mm, and in an exemplary embodiment may be 0.01 mm. Although metal plating 14 is described as being 0.05 mm to 0.5 mm in diameter, the diameter of the metal plating 14 may vary over a large range, depending upon the number of optical fibers 12 to be placed in the fiber optic cable 10. The metal plating 14 wall thickness may be selected to be sufficient for high temperature performance of the optical fiber 12.

The fiber optic cable 10 may operate without the metal plating 14 adhering to the outer tube 18 in temperatures up to 550° C. However, the fiber optic cable 10 may be used over a wider temperature range, depending on the selection of ceramic material in a ceramic fiber sleeve 16. Additionally, the ceramic fiber sleeve 16 may allow the optical fiber 12 and the metal plating 14 to relax and straighten with respect to an outer tube 18 due to differences in the coefficients of thermal expansion between the metal plated optical fiber 12 and the outer tube 18 and during spooling and deployment of the fiber optic cable 10. The viscosity of the ceramic fiber sleeve 16 may widely vary, depending on the specific cable design, including the diameter of the metal plated optical fiber 12 and the number of optical fibers in the fiber optic cable 10. The ceramic fiber sleeve 16 may also provide additional benefits of preventing chaffing of the metal plating 14 on the optical fiber 12 as a result of bending action during installation and vibration of the fiber optic cable 10. The ceramic fiber sleeve 16 may also serve as an integrator of metal plated optical fiber surface roughness to avoid microbend losses in the optical fiber 12. Suitable ceramic materials for use in the ceramic fiber sleeve 16 include 3M™ Nextel™ Braided Sleeving 312, 3M™ Nextel™ Braided Sleeving 440, other 3M™ Nextel™ Braided Sleeving, alumina magnesia silicate, any other material made of silica, or other ceramic based material that is stable at high temperatures.

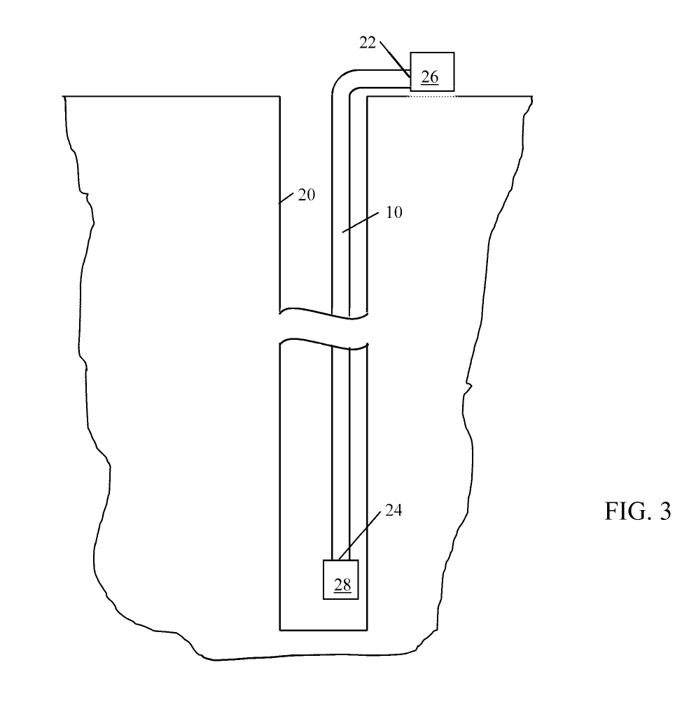

Referring now to FIG. 3, the fiber optic cable 10 may be used in a wellbore 20 of and oil, gas, or other hydrocarbon bearing well. The optical fiber 12 may be selected to provide reliable transmission of optical signals between a first end 22 and a second end 24 of the fiber optic cable 10, such as between a pulsed light source 26 and a light sensor assembly 28 positioned within the wellbore 20. The light source 26 and/or the light sensor assembly 28 may be coupled with optical signal processing equipment either downhole or at the surface. Suitable optical fibers 10 may include fibers such as those used by distributed sensing vendors such as Quorex and Sensornet, any other distributed sensing optical fiber, or any other optical fiber suitable for use in a high temperature environment. Multiple optical fibers 12 may be included in a fiber optic cable, of which any two optical fibers 12 may be of the same type or of different types. Although the embodiments described use a single optical fiber 12 with metal plating 14, it will be understood by those skilled in the art that more fibers may be used. The total number of fibers within the metal plating 14 or within the ceramic fiber sleeve 16 may be limited by the diameter of the metal plating or the ceramic fiber sleeve 16 such that sufficient space is provided within the outer tube 18 to prevent microbending of the optical fiber 12 during handing and deployment of the fiber optic cable 10.

The metal plated optical fiber 12 may be surrounded by a ceramic fiber sleeve 16 and an outer tube 18. For example, Ceramic Textiles and Composites (3M™ Nextel™ 440 Braided Sleeving). The ceramic fiber sleeve 16 may provide a mechanical link between the metal plated optical fiber 12 and the outer tube 18 to prevent the metal plated optical fiber 12 from sliding under its own weight within the outer tube 18. Additionally, the ceramic fiber sleeve 16 may keep the metal plated optical fiber 12 generally centered within the outer tube 18 and protect the optical fiber 12 and metal plating 14 from damage due to vibration. Suitable ceramic materials may include materials that are non-wetting to molten metal, so as to provide a barrier to prevent the metal plated optical fiber 12 from adhering to the outer tube 18 at high temperatures. In addition, suitable ceramic materials may include materials that reduce friction between the metal plating 14 and the outer tube 18, or other materials providing benefits in view of the present disclosure. For example, ceramic materials may include boron nitride or other suitable materials. The fibers of the ceramic fiber sleeve 16 may be braided, tied, or otherwise woven together, such that the ceramic fiber sleeve 16 includes woven ceramic fibers. Woven ceramic fibers may be prefabricated or ceramic fibers may be braided around metal plated optical fiber 12 inline. Depending on the construction and the desired application, the ceramic fiber sleeve 16 may have varying degrees of stiffness. For example, the ceramic fiber sleeve 16 may be flexible.

In one exemplary embodiment, the ceramic fiber sleeve 16 is placed between a 0.05-0.125 mm diameter metal plated optical fiber 12 and an 2.8 mm inner diameter outer tube 18 having a 2.8 mm inner diameter and a 3.2 mm outer diameter, in which case, the ceramic fiber sleeve 16 may have a thickness in the range of 1 mm to 2.8 mm, preferably 1.6 mm. Although a range of ceramic fiber sleeve 16 thickness is described, any suitable thickness of ceramic fiber sleeve 16 may be used, depending of the dimensions of the metal plated optical fiber 12 and outer tube 18, to provide the desired mechanical protection of the metal plated optical fiber 12 and/or to provide the mechanical linkage between the metal plated optical fiber 12 and the outer tube 18 to prevent relative movement therebetween.

The outer tube 18 may be manufactured of a heat and/or corrosion resistant material. For example, the outer tube 18 may be manufactured of stainless steel, Incolloys, or other metals. The outer tube 18 may be provided in a standard diameter (after draw down if applicable), such as 3.2 mm outer diameter and 2.8 mm inner diameter, and may have a diameter in the range of 1 mm to 8 mm. The outer tube 18 may have a wall thickness in the range of 0.1 mm to 2 mm.

The optical fiber 12 may be coated/plated with metal via painting, electroplating, or other methods useful for applying metal to an optical fiber. After the optical fiber 12 has been coated/plated with the metal plating 14, the metal plated optical fiber 12 may be placed in the ceramic fiber sleeve 16 and the ceramic fiber sleeve 16 may be placed in the outer tube 18. Placing the metal plated optical fiber 12 in the ceramic fiber sleeve 16 may be via threading the metal plated optical fiber 12 through the ceramic fiber sleeve 16, which may be formed in advance of placing the metal plated optical fiber 12 therein. Such threading of the optical fiber 12 into the ceramic fiber sleeve 16 may be done manually or automated, and may involve inserting a wire or other tension member into the ceramic fiber sleeve 16, attaching the tension member to the metal plated optical fiber 12, and applying tension to the tension member, thus pulling the metal plated optical fiber 12 into the ceramic fiber sleeve 16. Alternatively, the ceramic fiber sleeve 16 may be formed about the metal plated optical fiber 12 via braiding or winding ceramic fibers or a sheet formed of ceramic fibers around the metal plated optical fiber 12 while simultaneously forming the ceramic fiber sleeve 16, or by otherwise encasing the metal plated optical fiber 12 within the ceramic fiber sleeve 16. For example, the ceramic fibers may be braided about the metal plated optical fiber 12 in a manner similar to that used to form a woven copper shield about a plastic sheath in a coaxial cable. In various methods of placing the metal plated optical fiber 12 in the ceramic fiber sleeve 16, a lubricant may be used to reduce friction between the metal plated optical fiber 12 and the ceramic fiber sleeve 16. Suitable lubricants may include boron nitride, other high temperature ceramic lubricant powders, or other friction reducers. The lubricant may be applied to the exterior of the metal plating 14 of the optical fiber 12, to the interior of the ceramic fiber sleeve 16, or both.

Placing the ceramic fiber sleeve 16 in the outer tube 18 may be via threading the ceramic fiber sleeve 16 through the outer tube 18, which may be formed in advance of placing the ceramic fiber sleeve 16 therein. Such threading of the ceramic fiber sleeve 16 into the outer tube 18 may involve a process similar to that described above for threading of the optical fiber 12 into the ceramic fiber sleeve 16. Alternatively, the outer tube 18 may be formed about the ceramic fiber sleeve 16 via TIG weld, laser weld, or other suitable process for joining the outer tube 18 over the ceramic fiber sleeve 16 while simultaneously forming the outer tube 18. In various methods of placing the ceramic fiber sleeve 16 in the outer tube 18, a lubricant may be used to reduce friction between the ceramic fiber sleeve 16 and the outer tube 18. Suitable lubricants may include boron nitride, or other friction reducers. The lubricant may be applied to the exterior of the ceramic fiber sleeve 16, the interior of the outer tube 18, or both. Application of the lubricant may involve sprinkling of a fine powder as the threading takes place.

Systems and methods may include the use of the fiber optic cables 10 described above. One such system may include the outer tube 18, the ceramic fiber sleeve 16 within the outer tube 18, and a metal plated optical fiber 12 within the ceramic fiber sleeve 16. The system may also include the pulsed laser light source 26 at the first end 22 of the optical fiber 12 and the light sensor assembly 28 at the second end 24 of the optical fiber 12. The pulsed laser light source may be configured to transmit light pulses from the first end 22 of the optical fiber 12 to the light sensor assembly 28 at the second end 24 of the optical fiber 12 and the light sensor assembly 28 may be configured to receive light pulses from the pulsed laser light source 26. The light sensor assembly may be coupled with the optical signal processing equipment either downhole or at the surface. The optical signal processing equipment may be configured to process signals received by the light sensor assembly 28 to determine a variety of values for variables such as temperature, pressure, strain, sound or other conditions for which a measurement is desired in conjunction with optical fibers.

The fiber optic cables 10 described above may be used to measure a value of a variable. For example, a method of measuring a value of a variable may include providing the optic cable 10 including the optical fiber 12, allowing the pulsed laser light source 26 to transmit light pulses from the first end 22 of the optical fiber 12 to the light sensor assembly 28 located at the second end 24 of the optical fiber 12. The method may also include allowing the light sensor assembly 28 to receive light pulses from the pulsed laser light source 26, and, based on the received light pulses, the method may include calculating the value of the variable. Such calculation may be done via the optical signal processing equipment or otherwise. In some applications, the variable for which a value is to be measured is temperature. More particularly, the value to be measured may be a temperature in excess of 750° C. or even a temperature in excess of 2400° F.

Those of skill in the art will appreciate that many modifications and variations are possible in terms of the disclosed embodiments, configurations, materials, and methods without departing from their scope. Accordingly, the scope of the claims and their functional equivalents should not be limited by the particular embodiments described and illustrated, as these are merely exemplary in nature and elements described separately may be optionally combined.

1. A fiber optic cable comprising:
a outer tube;
a ceramic fiber sleeve within the outer tube; and
an optical fiber having a metal plating within the ceramic fiber sleeve.

2. The fiber optic cable of claim 1, wherein the outer tube comprises metal.

3. The fiber optic cable of claim 2, wherein the metal is selected from the group consisting of gold, and silver.

4. The fiber optic cable of claim 1, wherein the ceramic fiber sleeve comprises woven ceramic fibers.

5. The fiber optic cable of claim 1, wherein the ceramic fiber sleeve is flexible.

6. The fiber optic cable of claim 1, wherein the ceramic fiber sleeve comprises alumina magnesia silicate.

7. The fiber optic cable of claim 1, wherein a diameter of the optical fiber is between 0.01 mm and 0.2 mm.

8. The fiber optic cable of claim 1, wherein a diameter of the metal plating is between 0.05 mm and 0.5 mm.

9. The fiber optic cable of claim 1, wherein a thickness of the ceramic fiber sleeve is between 1 mm and 2.8 mm.

10. The fiber optic cable of claim 1, wherein a thickness of the outer tube is between 0.1 mm and 2 mm.

11. A method of forming a fiber optic cable comprising:
placing a metal plated optical fiber in a ceramic fiber sleeve; and
placing the ceramic fiber sleeve in a outer tube.

12. The method of claim 11, wherein the outer tube comprises metal.

13. The method of claim 12, wherein the metal is selected from the group consisting of gold, and silver.

14. The method of claim 11, wherein the ceramic fiber sleeve comprises woven ceramic fibers.

15. The method of claim 11, wherein the ceramic fiber sleeve is flexible.

16. The method of claim 11, wherein the ceramic fiber sleeve comprises ceramic fibers, and wherein the method comprises braiding the ceramic fibers around the metal plated optical fiber.

17. The method of claim 11, wherein placing the optical fiber in the ceramic fiber sleeve comprises threading the optical fiber into the ceramic fiber sleeve.

18. The method of claim 11, wherein placing the ceramic fiber sleeve in the outer tube comprises threading the ceramic fiber sleeve into the outer tube.

19. The method of claim 11, wherein placing the ceramic fiber sleeve into the metal outer tube comprises applying lubricant to the ceramic fiber sleeve, the metal outer tube, or both.
